(19) United States
(12) Patent Application Publication
(10) Pub. No.: US 2026/0050572 A1
(43) Pub. Date: Feb. 19, 2026

(54) CUSTOM DATA RETENTION

(71) Applicant: Notion Labs, Inc., San Francisco, CA (US)

(72) Inventors: Alma Wang, New York, NY (US); Rachel Chen, New York, NY (US); Bhavesh Viswanath, New York, NY (US)

(21) Appl. No.: 18/957,304

(22) Filed: Nov. 22, 2024

Related U.S. Application Data
(60) Provisional application No. 63/684,275, filed on Aug. 16, 2024.

(51) Int. Cl. G06F 16/11

(52) U.S. Cl. CPC G06F 16/125

(57) ABSTRACT

A method includes receiving a request to relocate a page from a first logical location to a second logical location within a first database. The method includes modifying a property of the page to reflect its new logical location. The method includes calculating a duration for the page to remain in the second logical location and, based on this duration and the current date, determining a deletion date for the page. The deletion date, along with the page's space identifier, can be stored in a second database that maintains a mapping between space identifiers and deletion dates. The method can include querying the second database to identify workspaces with a deletion date that matches the current date. The method can include identifying pages with a deletion date matching the current date. The method can update a property of each identified page to indicate its relocation to a third logical location.

### CROSS REFERENCE TO RELATED APPLICATIONS

This application claims the benefit of priority to U.S. Provisional Application No. 63/684,275, filed Aug. 16, 2024, the contents of which are incorporated by reference in its entirety.

### BACKGROUND

The retention of electronically stored information can be important in a wide range of scenarios. However, there are problems with current approaches to data retention. Accordingly, improvements to data retention are needed.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 is a flowchart that illustrates an example page deletion process according to some implementations.

FIG. 5 schematically illustrates a live page, trashed page, and retained page according to some implementations.

FIG. 6 is a flowchart that illustrates an example process for restoring a retained page according to some implementations.

FIG. 7A is a drawing that schematically illustrates a user interface for configuring deletion and retention times according to some implementations.

FIG. 7B shows an example user interface for changing a deletion period or a retention period according to some implementations.

FIG. 8 shows an example search interface according to some implementations.

FIG. 9 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Data retention relates to the storage, archiving, and disposal of data. Data retention policies can be important for a variety of reasons. For example, certain regulated industries may be required to maintain records for a minimum amount of time or to destroy records in certain circumstances, such as after a certain amount of time, at the request of certain organizations or individuals (e.g., patients), and so forth. Different industries and jurisdictions have different requirements for how long certain types of data must be retained. For example, financial institutions are often required to retain transaction records for several years to comply with regulations such as Sarbanes-Oxley. Healthcare providers must adhere to HIPAA requirements, which mandates retention periods for patient health records.

Data retention policies can also be important for protecting sensitive information. For example, by defining how long data should be kept and when it should be deleted, organizations can reduce the risk posed by data breaches, for example, by ensuring that data is deleted after a set period of time. This can be particularly important in the context of personal information, where regulations such as the General Data Protection Regulation (GDPR) and California Consumer Privacy Act (CCPA) impose certain limitations on data retention and sharing or expose data holders to significant liabilities if data is improperly maintained or secured.

When organizations are the subject of lawsuits, they may be required to preserve certain information. Spoliation of evidence can have significant impacts on litigation, for example allowing a jury or other trier of fact to draw negative inferences. Litigants who engage in the spoliation of evidence can face significant repercussions, such as monetary sanctions, limitations on damages, the striking of pleadings, prevention of the introduction of evidence, being barred from proceeding with certain claims or defenses, default judgment, or dismissal.

Data retention policies can also be important for internal investigations. For example, in a suit alleging sexual harassment, an employee may want to delete e-mails, chat messages, and so forth to prevent them being uncovered during an internal investigation. As another example, an employee or former employee who engages in trade secret theft may try to cover their tracks by deleting information that could expose them, such as deleting an email they sent to their personal account that includes trade secret information or deleting a page that they shared with a guest user.

Even absent required retention times, investigations, and other considerations described above, an organization may want to impose a retention policy for technical reasons, such as to reduce the amount of storage needed for their data or improve performance of tools such as search engines by removing data that is no longer needed. As an example, organizations may want to automatically purge deleted items to conserve space and limit the amount of information stored by the organization.

While retaining information can have certain advantages or even be required in some circumstances, data retention presents significant challenges. For example, if information is left in place rather than being archived, it can be difficult for users to find the information they need. For example, employees may consult an outdated version of a handbook or outdated plans for a project if there is no separation between current information and old information that is being retained. Additionally, if users can access old information, they may, depending upon the specific configuration, be able to edit or otherwise tamper with older information.

In some cases, users may utilize a trash or similar feature to archive older information. However, this approach can be highly problematic as it may be unclear which items in the trash are intended to be deleted and which should be retained but have been moved to the trash for other reasons, such as to maintain organization among live information.

In some cases, it can be important to be able to recover deleted information for business continuity. For example, an employee within an organization might accidentally delete information. In some cases, an employee or other nefarious actor may intentionally delete information. As described herein, in some implementations, an administrator (e.g., a workspace owner) can restore pages or other items from trash or, in some implementations, can restore pages or other items even after they are deleted from the trash.

Accordingly, it can be important for software—and especially software targeted at enterprises, professional organizations, and so forth—to provide data retention functionality. Different organizations can have significantly different retention needs.

Knowledge management platforms, such as Notion, are increasingly essential tools for both organizations and individuals. Knowledge management platforms can be used to streamline information sharing, collaboration, and productivity. Knowledge management platforms provide a powerful way to capture, store, organize, and disseminate information within an organization. Knowledge management platforms can provide a wide range of functionality, such as note-taking, task management, database creation, document creation, wiki creation, and so forth in a cohesive workspace. Knowledge management platforms can take what was otherwise spread across multiple applications and combine it into a single source, making it easier for users to find the information they need and enabling a wide range of collaboration and integration that would otherwise be difficult or impossible.

Given the myriad benefits of using knowledge management platforms, important information is increasingly stored in such platforms. A platform can store, for example, financial information, protected health information, attorney-client communications, operational information, and so forth, which may need to be retained for compliance, investigations, business continuity, and so forth.

However, it can be important to remove certain information, such as older financial reports, outdated policies, and so forth from the platform, for example so that users can more easily locate relevant, up-to-date information. In some cases, an organization may want to archive such information in a manner that is accessible to users. However, in other cases, an organization may want to hide certain retained information from users.

In some implementations, a platform can use a tiered approach for deleting information. For example, information can be moved to the trash, where it can remain until it is deleted. In some implementations, information can remain in the trash until manually deleted. However, as described herein, it can be important to automatically delete information from the trash. In some implementations, when a page is deleted from the trash, it can become a retained page that is hidden from users but accessible to an administrator (e.g., a workspace owner) until a retention period expires. For example, a knowledge management system can be configured to delete pages from the trash automatically after 30 days, but to retain the deleted pages for two years. The retention period can be calculated from various dates, such as the date a page was created, the date a page was last edited, the date a page was moved to the trash, or the date the page was deleted from the trash.

To facilitate robust retention policies, investigatory capabilities, and so forth, it can be significant to ensure that accurate metadata is generated and retained. For example, it can be important to have an accurate record of when a page was moved to the trash, when the page was deleted from the trash, when the page was restored from the trash, when the page was exported, who moved the page to the trash, who deleted the page from the trash, who restored the page, who exported the page, and so forth. In some embodiments, metadata can be generated and associated with the page to record such information. In some cases, such metadata can be hidden from users, or may be viewable but not editable by users. This is in contrast to some other types of metadata, which can be editable by users in some circumstances.

As described herein, pages can be in various states. As used herein, a page can be live, referring to a page that is published and viewable by users, trashed, in which case the page can be viewed by navigating to the trash, retained, in which case the page still exists but is not visible to users (or is only visible to certain users such as administrators), or purged, in which case the page no longer exists (e.g., its record(s) are deleted from a database). Different states can be referred to as logical locations. That is, a live page, trashed page, and retained page can all still exist in a production database, but properties of the pages can vary depending on the logical location of the page. That is, moving a live page to the trash or moving a trashed page out of the trash and making it a retained page may result in modifications to a database record for the page, but the database record may not be deleted.

### Page Trash, Deletion, and Purging

Deleting information is a common operation, and various approaches can be used. For example, in the context of file deletion, files can be deleted immediately upon user request or moved to a temporary staging area (e.g., “Trash” or “Recycle Bin”) and later permanently deleted, either at user direction or after a specified period (e.g., 30 days). Cloud storage services can operate similarly, providing a temporary staging area from which deleted files can be recovered before they are permanently deleted, either automatically or at user direction.

In some cases, it can be desirable for administrators or other authorized individuals to be able to recover information even after it is deleted. Various approaches can be used to accomplish this, such as exporting information and saving the exported information should it be needed in the future. However, exporting data can be a time- and computationally-intensive process, and there is a risk that exported information may not always be up to date, resulting in the loss of some information. For example, pages may be purged before an administrator exports them.

In the context of a knowledge management system, information can be stored in files, database records, etc. When a user deletes a record in a database, the record can be deleted immediately or scheduled for deletion. In some implementations, the record can include a field that indicates if the record has been deleted or not, and an application that uses the database may hide records that are marked as deleted from users, even though the records still exist. In some cases, a user may be able to access a trash or analogous page or area to see records that have been deleted but which still remain in the database.

In some implementations, pages are stored in a database. In some embodiments, a knowledge management system is organized according to a block model, for example as described herein. A page can comprise a block and one or more child blocks. A page can be associated with an ancestor block. An ancestor block can be, for example, a parent page of the page. The page can have various properties, permissions, etc., (generally referred to herein as metadata or properties) associated therewith. In some implementations, when a page is moved to the trash, the metadata of the page can be updated to indicate that the page is in the trash. For example, the page can include a property that indicates that the page is in the trash. In some implementations, the page can include a property that indicates when the page was moved to the trash (e.g., “moved_to_trash_time”). In some implementations, the page includes a property that indicates who moved the page to the trash (e.g., “moved_to_trash_by_id”). The moved_to_trash_id property can be an identifier that uniquely identifies the user who moved the page to the trash. In some implementations, the page includes a property that indicates a table where the ID of the user who moved the page to the trash can be retrieved (e.g., “moved_to_trash_by_table”). For example, a platform can be configured to query the identified table using the identifier to retrieve information about the user who moved the page to the trash.

In some implementations, when a page is moved to the trash or deleted from the trash and the page comprises multiple blocks (e.g., a parent block and one or more child blocks), only the parent block may be updated. This can be advantageous as it reduces computational demands associated with deleting pages. Child blocks can inherit status information from their parent block. For example, if a parent block is marked as in the trash, the platform can also treat the child blocks as being in the trash, even though the metadata of the child blocks does not necessarily indicate that they are in the trash.

The date the page was moved to the trash can be used for performing subsequent calculations, such as when to delete the page from the trash or when to purge a retained page. Similarly, when a page is deleted from the trash but is still in a retained state (e.g., not removed from the database), the page's metadata can be updated to indicate that the page is deleted, such that the page is not visible to users navigating the knowledge management system or viewing the trash. In some implementations, a permission is set for the page (e.g., “deleted_permission”) such that users cannot see or access the page after it is deleted from the trash.

In some implementations, pages include metadata indicating when to delete the page from the trash. In other implementations, pages do not include an explicit indication of when to delete the page from the trash. This can be significant because, for example, if the deletion date is stored as part of the page's record and a time period for how long pages remain in the trash (trash time) or how long pages are retained (purge time or retention time) is changed, the platform can need to recalculate the deletion dates and/or purge dates.

Various other approaches can be used additionally or alternatively. For example, rather than storing metadata for page deletions in records in a production database (e.g., as part of a block in a platform that uses a block model as described herein), such information can instead be stored in a separate table. The separate table can store metadata for trashed pages, deleted pages, or both. However, this can present a significant performance issue. As an example, when a user loads a trashed page, if the page displays the time the page was moved to the trash or other information indicating that the page is in the trash, the platform can perform a join operation to obtain the time or other information from the separate table and the page's content from the production table.

Another alternative is to utilize existing metadata, such as last edited time, to determine when a page was moved to the trash. However, this approach can interfere with other usage scenarios in which the last edit time is updated. Additionally, it can be significant to have separate values for last edited time and trashed time, as these times can be different and relate to different concepts.

In some implementations, the block model is updated to include a property for a time when the page is deleted from the trash (e.g., deleted_from_trash_time). This can be an optional column that is not populated unless the page is deleted from the trash. In some implementations, the time when the page is deleted from the trash can be set when the page is removed from the trash and can be unset if the page is later restored after being deleted from the trash.

One difficulty associated with knowledge management platforms is the large amount of information contained within. While a platform with only dozens or hundreds of pages can be relatively easy to manage, approaches that work for such small amounts of data, such as scanning through all pages in a database to identify pages for deletion or purging, may perform poorly in larger contexts. A workspace can have hundreds, thousands, or millions of pages. Thus, page deletions and other wide-scale operations can take significant computing resources and significant time to complete. For example, a simple approach to deleting pages from the trash can include querying a production database for all pages with properties that indicate the page should be deleted from the trash. However, such an approach can unnecessarily consume computing resources. While a workspace may contain a large number of pages, it is likely that typically, only a small fraction will be in the trash and scheduled for deletion on a particular date.

In some implementations, deletion information can be stored in a deletion database. The deletion database can be a separate database, such as a NoSQL key-value datastore (e.g., Amazon DynamoDB) or can be a separate table in another database, such as a production database. The deletion database can store identifiers of pages to be deleted, identifiers of workspaces with pages to be deleted, deletion dates, purge dates, and/or the like. In some implementations, pages are organized into spaces (e.g., workspaces, teamspaces). In some implementations, the platform is configured to query the deletion database to identify spaces with pages to be deleted. For example, the platform can execute a daily job that queries the deletion database to identify spaces with pages to be deleted. Typically, only a small fraction of spaces will have deletions for a given day. By storing space identifiers and deletion dates in the deletion database, computational resource demands can be significantly lessened as there is no need to execute queries over all spaces to determine which pages to delete on a given day. Instead, queries can be performed only on spaces indicated in the deletion database.

In some implementations, when a page is moved to the trash (e.g., as a result of action by a user), metadata of the page is updated to indicate that the page is in the trash. The page can be associated with a space having a space identifier (spaceID), and the spaceID and deletion date (or trash date) can be written to a deletion database. The database can be, for example, a key-value store that maps deletion dates (or trash dates) to spaceIDs. A daily task can be queued to delete pages from the trash. The daily task can query the deletion database to determine spaceIDs with pages to be deleted, for example, by searching for spaceIDs with a deletion date that is equal to the current date. The platform can query the production database to identify pages in each determined spaceID with pages to be deleted and can update the pages to indicate that they are deleted, for example by setting metadata, such as setting a deleted_permission that indicates that page is deleted. In some implementations, the platform deletes pages as part of a single job that includes multiple spaceIDs. In some implementations, the platform queues multiple jobs, e.g., one job per spaceID, and each job deletes pages from within a single spaceID.

In some implementations, failsafe mechanisms can be included in the platform. For example, the platform can periodically search for pages with deletion dates less than the current date (e.g., deletion dates in the past) and can delete those pages. This can be significant as errors or failures can occur during deletion processes, and such failsafes can help to ensure that pages are deleted even in the case that errors occur that cause pages not to be deleted as scheduled. As an example, a page may not be deleted as scheduled if a database record for the page is locked at the time of deletion such that updates to the page's record cannot be made. For example, another operation may be running that prevents deletion of the page.

Purging pages can operate in a manner that is similar to or the same as the process described herein for deleting pages from the trash. When a page is deleted from the trash, it can become a retained page. Retained pages are typically not visible to users but can be accessed by administrators, who may have a need to access, restore, or otherwise interact with retained pages. Retained pages can remain in the database until the expiration of a defined retention period. In some embodiments, the deletion database can also store a mapping of spaceIDs and dates when pages associated with a spaceID are to be purged. In some embodiments, purge data can be stored in a separate database, e.g., a separate NoSQL key-value store.

When a page is purged, the page (e.g., the main block for a page and any child blocks of the page) can be permanently removed from the production database. A daily scheduled job can be used to identify pages to be purged and to purge those pages from the production database. In some implementations, the purging is performed using a scheduled job that checks a ready to purge database for workspace and/or pages, and attempts to purge the ready to purge pages and/or workspaces from the production database.

### Page Restoration

In some cases, it can be important to restore pages that have been moved to the trash or deleted from the trash. However, there can be significant issues associated with restoring deleted or trashed files, pages, etc. For example, when a file is deleted or trashed, a system may not retain metadata associated with the file, such as permissions, original file location, etc. If permissions are not preserved, the system cannot restore the file with its original permissions. In some cases, deleting or trashing pages in a knowledge management platform can involve deleting database records, which may be used to store permissions.

In some implementations, a knowledge management platform can be configured to preserve permission information when a page is deleted. Permission information can include permissions for specific users, groups, teamspaces, guests, etc. In some implementations, when a page is restored, a workspace owner can choose to apply default permissions, apply custom new permissions, or restore previous permissions. In some implementations, when a page is restored, previous permissions are restored, but guest access permissions may not be restored, which can help to ensure that access to pages is not inadvertently granted to individuals who should not have access.

Restoring original permissions for a page in a knowledge management platform can have certain complications. For example, different users can be members of different groups, can have different roles, etc. Some users can be owners, editors, viewers, etc. In some cases, guests may be granted access to pages. In some cases, a page's owner may have left the organization and their account may be deactivated or no longer exist. In some implementations, a knowledge management platform can be configured to address such scenarios. For example, when a page is restored, guest access may not be restored, a page owner may be changed (for example, to a workspace owner) of the page's original owner is no longer active, and so forth.

In a knowledge management platform, permission information can be stored in a variety of manners. For example, in some cases, permission information can be stored in a table different from a table that stores content. When a user moves a page to the trash, the permission information can be purged from a permissions table. In some embodiments, permission information is stored with each block or with each parent block or page. For example, a page can have permissions associated therewith, and the blocks that make up the page can inherit permissions from the parent block. In some cases, different blocks can have different permissions. Thus, for example, when a first user with first permissions views a page, they may see content that is different from that seen by a second user with second permissions.

In some implementations, permissions associated with one or more blocks can be preserved until the page that is made up of the one or more blocks is purged from the production database. For example, if permissions information is stored as part of a block, the permissions information can be preserved until the block is purged from the database. If the permissions information is stored in a separate table, the permissions information may not be deleted until the page is purged from the database.

### Deletion Time and Retention Time Modification

In some cases, an organization may have a need or want to change a period of time when pages remain in the trash or a retention period for retaining documents after deleting them from the trash. In such cases, it can be important to adjust deletion and purge times for previously-trashed documents to ensure that they are deleted according to the revised timing.

As described herein, in some implementations, identifiers of workspaces with pages to delete, identifiers of pages to delete, or both can be stored in a deletion database. In some implementations, the deletion database can store dates on which pages are to be deleted. For example, an entry in the deletion database record for a workspace can include a date on which pages in the workspace are to be deleted. As another example, a deletion database record for a page can include a date on which the page is to be deleted (e.g., removed from the trash). In some implementations, the deletion database stores workspace identifiers (spaceIDs) and dates on which pages in the workspaces associated with workspace identifiers are to be deleted, but the deletion dates for specific pages are stored in the production database or are not stored but rather calculated, for example based on a time when the page was moved to the trash.

When a deletion time is shortened or extended, the platform can be configured to update deletion dates in the deletion data, in the production database, or both. For example, if the deletion time is extended, the platform can query the deletion database, the production database, or both for pages that have been moved to the trash and can determine a new deletion data for each page in the trash. In some implementations, the platform can be configured to update the mapping of spaceIDs and deletion dates based on the updated deletion time.

The platform can operate similarly when deletion times are shortened. For example, if a space previously had a deletion time of 30 days (e.g., a page would remain in the trash for 30 days prior to being deleted) and the deletion time is updated to 14 days, the platform can update the spaceID and deletion date mapping based on the shortened deletion time. When the deletion time is shortened, it can be the case that some pages that have not yet been deleted because their deletion date had not yet occurred under the previous deletion time, but they should be deleted under the new deletion time. In some implementations, the platform can query the deletion database, the production database, or both to identify pages that have not yet been deleted from the trash but should be based on the updated deletion time and can queue a deletion job to delete the identified pages.

The same or similar processes can be used when a retention period is expanded or deleted. However, unlike deletions, which are reversible, pages cannot be restored after the retention period has ended and the pages have been purged. Thus, for example, if a space was set to purge deleted items after one year and the retention time is subsequently updated to two years, this updated retention period can be applied to pages that have not yet been purged, but cannot be applied to pages that have already been purged and thus no longer exist in the production database.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No” ]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database-meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

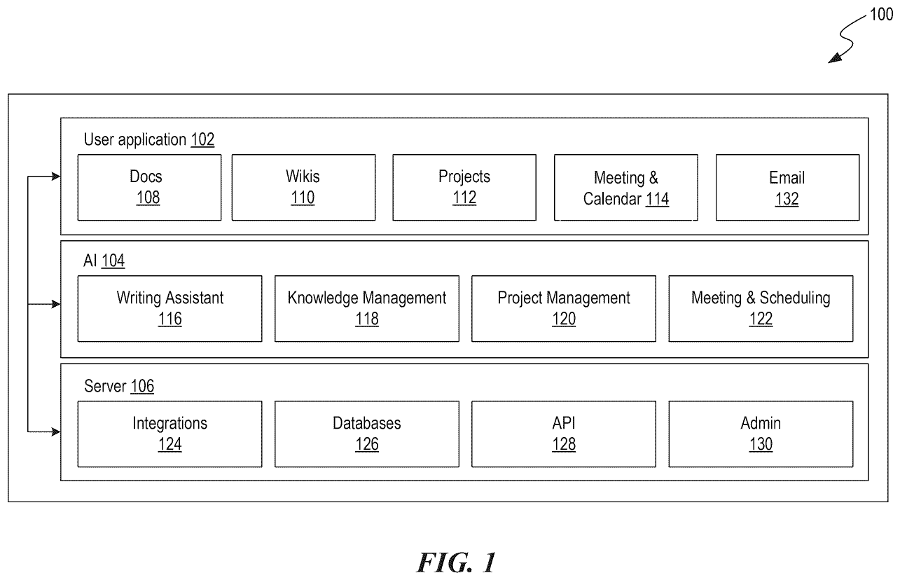

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the system 100 to another email address within the system 100, can include an embedding of a document within the system 100, or an embedding of a block in the document. In another example, a wiki can link to a meeting within the calendar.

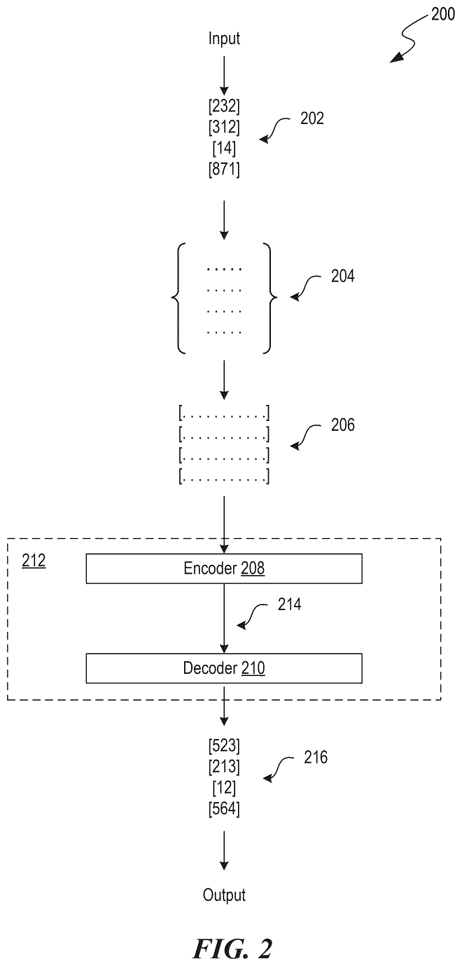

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

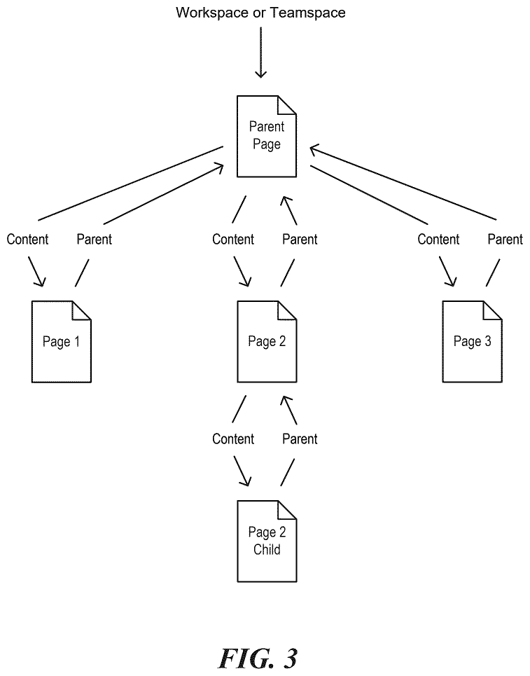

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Implementations

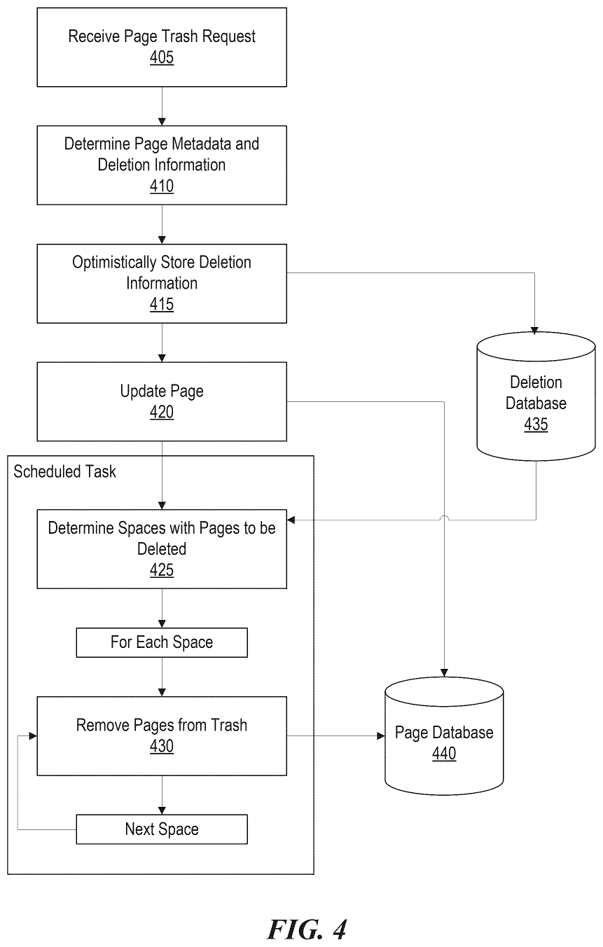

FIG. 4 is a flowchart that illustrates an example page deletion process according to some implementations. At operation 405, a platform can receive a request to move a page to the trash. At operation 410, the platform can determine page metadata, deletion information, or both for the page, such as a spaceID of a space associated with the page and a deletion date for the page (e.g., current date plus a deletion time, where deletion time specifies how many days a page remains in the trash before being deleted). At operation 415, the platform can (optimistically) store the deletion information in a deletion database 435. At operation 420, the system can update the page (e.g., metadata for the page), such as by changing “alive: true” to “alive: false” for a parent or main block of the page. In some implementations, updating the metadata for the page includes adding a time the page was moved to the trash, an identifier of a user who moved the page to the trash, and a name of table for mapping the identifier to a particular user. The update to the metadata can be stored in the page database 440, which can be a production database. Updating the metadata can cause the platform to only show the page when a user visits the trash or another designated location for viewing trashed pages. As described herein, the deletion database can be a key-value store that maps spaces (e.g., spaceIDs) and deletion dates. Operations 425 and 430 can be part of a scheduled task that runs, for example, once per day. At operation 425, the platform can determine spaces with pages to be deleted. For example, the platform can query the deletion database 435 to retrieve a list of spaceIDs that have deletion dates matching the current date. For each space with at least one page to be deleted, the system can queue a process at operation 430 to remove the at least one page from the trash. Removing a page from trash can include updating metadata of the page in the page database 440, for example to add a permission such as “deleted_permission.” The page can still exist in the page database 440, but may not be visible to users.

While FIG. 4 shows separate removal processes for each space, this is not necessary. While such an approach may offer certain advantages (such as easily re-queuing individual removal jobs that fail), in some cases, a single job can be performed to remove pages associated with multiple spaces.

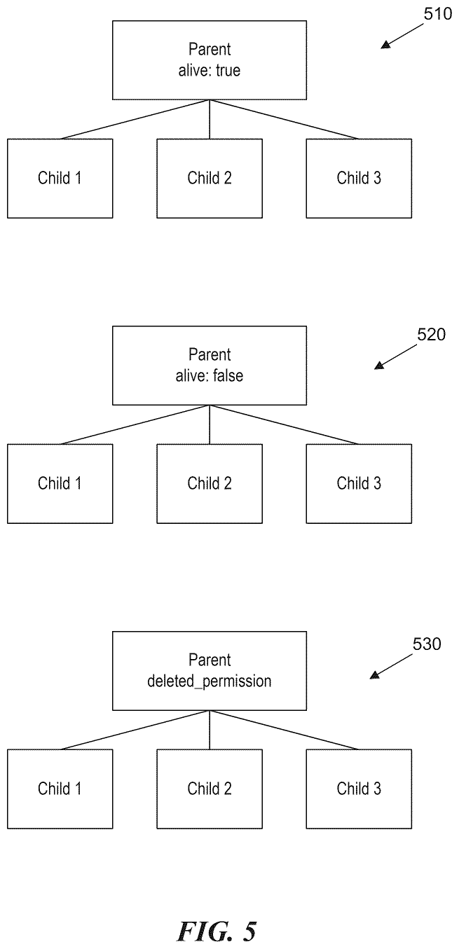

FIG. 5 schematically illustrates a live page 510, a trashed page 520, and a deleted page 530. The live page 510 can be a page that is available to users (e.g., users with appropriate access permissions). The trashed page 520 can be a page that is in the trash, e.g., a page that appears when a user visits the trash but cannot be edited. The deleted page 530 can be a page that still exists in a production database but is not visible to users. Metadata can be used to indicate a current status of the page. In FIG. 5, a page includes a parent block and child block, though in some implementations a page may not include any child block. When the parent page is live, the parent can have a property set to a value indicating that the page is live (e.g., alive: true in the example of FIG. 5). When a page is moved to the trash, the metadata can be updated to indicate that the page is in the trash (e.g., alive: false). When the page is removed from the trash, the page can still exist in a database, but its metadata can be updated to reflect that the page is deleted (e.g., by setting a value such as deleted_permission or otherwise updating metadata associated with the page). When the page is live, the page can appear normally to users, and users can, with appropriate permissions, edit or otherwise modify the page. When the page is in the trash, the page may not appear normally within the live pages but can be accessible by navigating to the trash. In some implementations, a page in the trash cannot be edited. When a page is deleted, the page may not be visible to users, but may still be available for administrators to access, for example by navigating to a UI that enables restoration of deleted pages. Deleted pages can remain in the database until a defined retention period expires.

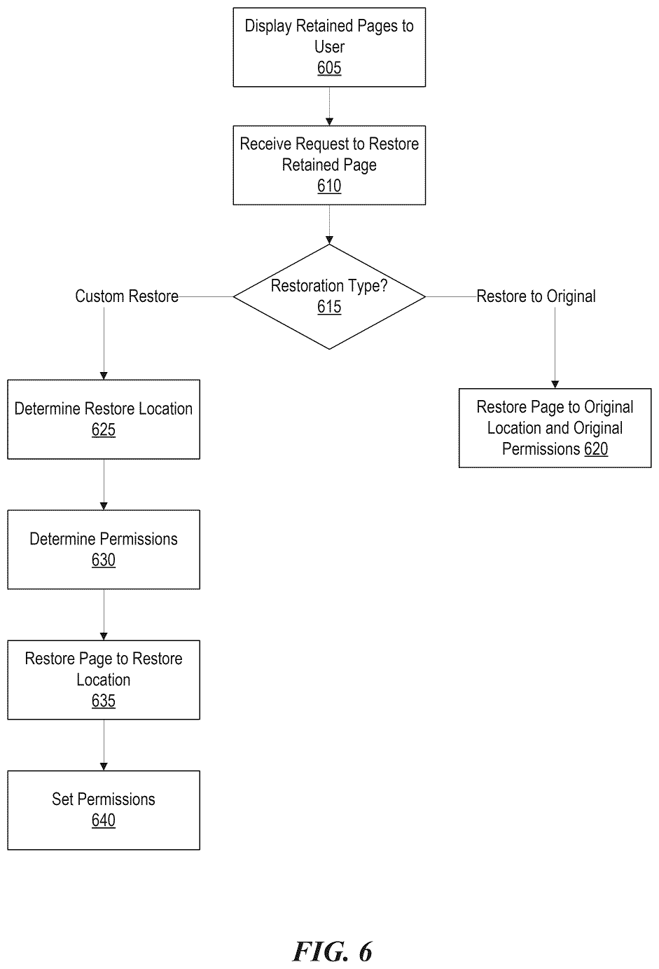

FIG. 6 is a flowchart that illustrates an example process for restoring a retained page (e.g., a page that has been deleted but not yet purged) according to some implementations. At operation 605, a platform can display a listing or other presentation of retained pages to a user. The listing may only be available to certain users, such as administrators or workspace owners. At operation 610, the platform can receive a user selection of a retained page to restore. At operation 615, the platform can determine, for example based on a user input, a type of page restoration. If the user selects to restore the retained page to its original location, the platform can restore the retained page to its original location and can restore the retained page's permissions at 620. In some implementations, the user can select permissions to apply to the restored page. For example, the user can select to restore the page's original permissions or to apply a set of default permissions to the page. In some implementations, original permissions are only partially restored. For example, guest access to the page may not be restored.

If, at operation 615, the restoration type is a custom restore, the platform can determine a restore location at operation 625. In some implementations, the user specifies a restore location. For example, the platform can provide a user interface that the user can use to specify a location to restore the retained page to. In some implementations, the platform restores the page to a predefined location, such as the user's private pages or a dedicated space for restored retained pages. At operation 630, the platform can determine permissions. For example, in some implementations, the user specifies permissions to apply to the page. In some implementations, the platform automatically applies a set of predefined permissions to the restored page. For example, the predefined permissions can include access for the user, access for administrators, etc. In some implementations, the page inherits default permissions from the space to which it is restored. At operation 635, the system can restore the page to the restore location. Restoring the page can include updating metadata of the page, for example to remove an ancestor page identifier or change an ancestor page identifier, as restoring the page to a different location than its original location can mean that the page is no longer in the same logical place in a hierarchy of pages or blocks. Restoring the page can change a status of the page, for example by removing an indication that the page is deleted and updating an indication to show that the page is live (e.g., removing deleted_permission and changing alive: false to alive: true). At operation 640, the platform can set the permissions for the page.

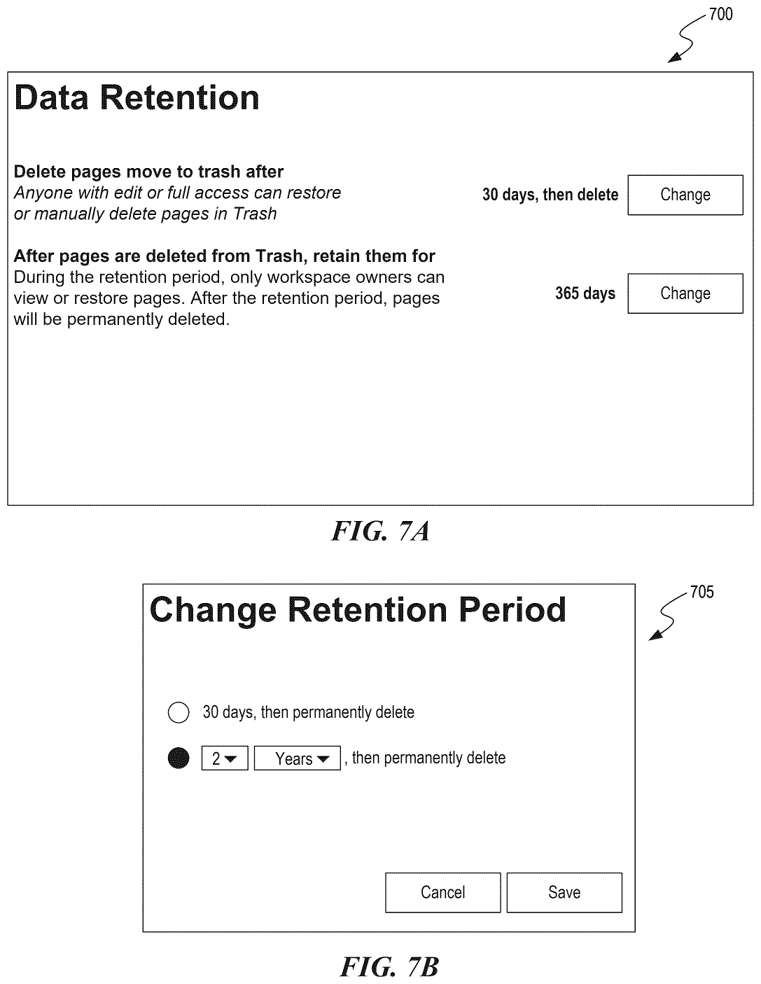

FIG. 7A is a drawing that schematically illustrates a user interface for configuring deletion and retention times according to some implementations. The user interface 700 can show a current deletion time, indicating a time after which pages are deleted from the trash. The user interface 700 can provide explanatory information, such as indicating that while pages are in the trash, users with edit or full access to restore or manually delete pages in the trash. The user interface 700 can include a button that allows a user to configure how long a page remains in the trash before being deleted.

The user interface 700 can show a current retention period and a button to allow users to change the retention period. The user interface 700 can provide explanatory information, such as indicating that during the retention period, only workspace owners can view or restore pages, and that once the retention period expires, pages will be permanently deleted.

FIG. 7B shows an example user interface 705 that can be shown to a user when the user clicks a button in the user interface 700 to change a deletion period or a retention period. FIG. 7B illustrates an example of a user interface for changing a retention period, but an interface for changing a deletion period can be largely the same. The user interface 705 includes various options for the user. For example, the user can select a default retention period or can specify a custom retention period. In some implementations, the user interface 705 can include a dropdown or input box for selecting a value and another dropdown or input box for selecting a unit (e.g., days, weeks, months, years).

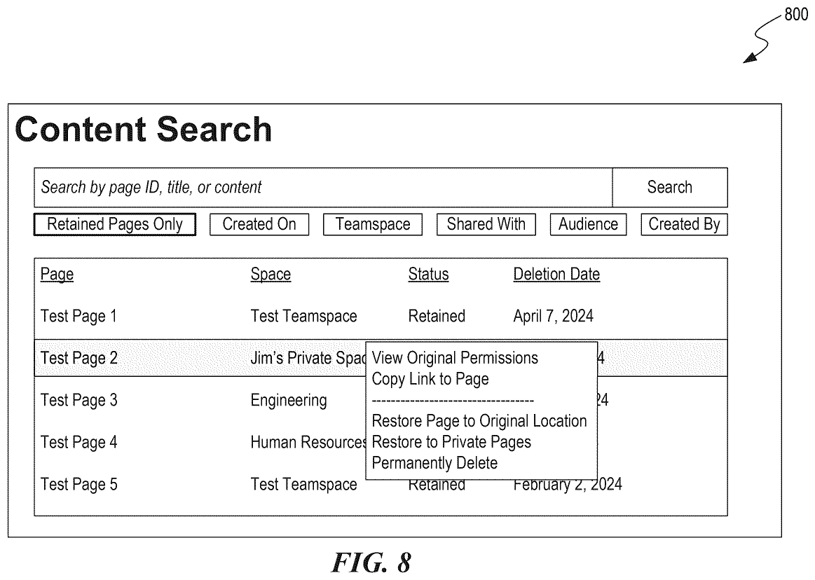

FIG. 8 shows an example search interface 800 according to some implementations. The search interface can allow workspace owners or other administrators to search for retained pages (e.g., pages that have been deleted from the trash but not yet purged from a database). The search interface 800 can include a search box that allows a user to search by a page identifier, page title, page content, etc. The search interface 800 can include various filters that can be used to refine the search. For example, a user can search only for retained pages, only for pages created on, after, or before a certain date, within a particular teamspace, shared with particular groups or individuals, with a particular specified audience, and/or created by a particular user or group.

The search interface 800 can show a list of pages matching the search criteria. The list can include, for example, page title, space where the page is located (e.g., where the page was deleted from), page status (e.g., alive, trashed, retained), deletion date, and/or the like.

When a user selects a page in the search results, the interface can provide the user with various options for interacting with the page. For example, as shown in FIG. 8, the user can view the page's original permissions, copy a link to the page, restore the page to its original location (e.g., with its original permissions), restore to the user's private pages (e.g., with custom permissions), or permanently delete the page. In some implementations, permanent deletion can be disabled to so that users, even workspace owners, are not able to override an organization's retention policies.

### Computer System

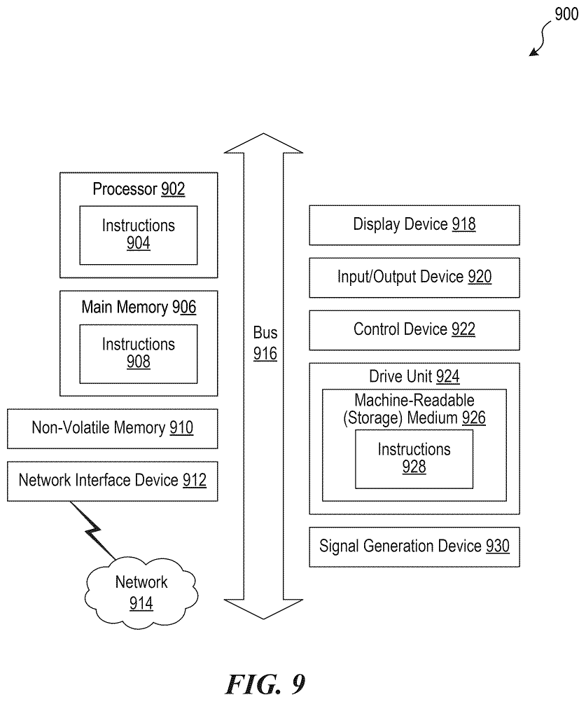

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a display device 918, an input/output device 920, a control device 922 (e.g., keyboard and pointing device), a drive unit 924 that includes a machine readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computer system 900 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 900. In some implementations, the computer system 900 can be an embedded computer system, a system-on-chip (SOC), a single-board computer (SBC) system, or a distributed system such as a mesh of computer systems or include one or more cloud components in one or more networks. Where appropriate, one or more computer systems 900 can perform operations in real time, near real time, or in batch mode.

The network interface device 912 enables the computer system 900 to mediate data in a network 914 with an entity that is external to the computer system 900 through any communication protocol supported by the computer system 900 and the external entity. Examples of the network interface device 912 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computer system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computer system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

1. A computer-implemented method for managing pages in a first database, the computer-implemented method comprising:
receiving a first user request to move a page from a first logical location to a second logical location,
wherein the first logical location is a live location,
wherein the second logical location is a trash,
wherein the page comprises a page identifier,
wherein the page is associated with a workspace having a space identifier, and
wherein the page is stored in the first database,
modifying a property of the page in the first database to indicate that the page is in the second logical location;
determining a deletion time, the deletion time indicating an amount of time for the page to remain in the second logical location;
determining, based on the deletion time and a current date, a deletion date for the page;
storing, in a second database, the deletion date and the space identifier,
wherein the second database is configured to store a mapping between a plurality of space identifiers and a plurality of deletion dates, each space identifier associated with a different workspace;
querying the second database to determine one or more space identifiers associated with a deletion date matching the current date;
determining one or more pages associated with each of the determined one or more space identifiers with a deletion date equal to the current date; and
updating a property of each of the one or more pages to indicate that the page is in a third logical location,
wherein the third logical location indicates a deleted state, and
wherein pages in the deleted state are not visible in the live location or the trash.

2. The computer-implemented method of claim 1, further comprising:
identifying, for each of the one or more pages in the third location, a purge date, wherein the purge date is determined based on the current date and a retention period;
determining, based on the current date and the purge dates for each of the one or more pages in the third logical location, one or more pages to be purged; and
purging the one or more pages to be purged,
wherein purging the one or more pages to be purged comprises deleting database records in the first database associated with the one or more pages to be purged.

3. The computer-implemented method of claim 1, wherein the second database is a key-value store.

4. The computer-implemented method of claim 1, wherein determining one or more pages associated with each of the determined one or more space identifiers with a deletion date equal to the current date comprises:
querying the first database to identify pages associated with the determined one or more space identifiers and having a deletion date equal to the current date.

5. The computer-implemented method of claim 4, wherein the deletion date is determined by adding the deletion time to a time when the page was moved to the second logical location.

6. The computer-implemented method of claim 1, wherein updating a property of each of the one or more pages to indicate that the page is in a third logical location is performed using a plurality of processes, wherein each process of the plurality of processes is configured to perform the updating on pages associated with a space identifier of the one or more space identifiers.

7. The computer-implemented method of claim 1, wherein the page comprises a parent block and a child block, and
wherein modifying a property of the page in the first database to indicate that the page is in the second logical location comprises modifying a property of the parent block.

8. The computer-implemented method of claim 2, further comprising:
providing, in response to a second user request from a user, a list of pages in the third logical location;
receiving a third user request from the user to restore a selected page from the third logical location to a fourth logical location; and
restoring the selected page to the fourth logical location.

9. The computer-implemented method of claim 8, wherein the fourth logical location is the first logical location, and wherein restoring the selected page to the fourth logical location comprises:
updating metadata of the selected page to indicate that the selected page is in first logical location; and
applying a set of permissions to the selected page, the set of permissions configured to at least partially match a previous set of permissions of the selected page before the page was moved from the first logical location to a second logical location.

10. The computer-implemented method of claim 8, further comprising:
determining a private space of the user;
identifying the fourth logical location as the private space of the user;
determining a set of permissions to apply to the selected page, wherein the set of permissions is at least one of: a set of permissions provided by the user or a set of default permissions for the private space of the user; and
updating metadata of the selected page to indicate that the page is in the private space of the user; and
applying the determined set of permissions to the selected page.

11. A system for managing pages in a first database, the system comprising:
a processor; and
a non-volatile computer readable storage medium having instructions stored thereon that, when executed by the processor, cause the system to perform operations comprising:
receiving a first user request to move a page from a first logical location to a second logical location,
wherein the first logical location is a live location,
wherein the second logical location is a trash,
wherein the page comprises a page identifier,
wherein the page is associated with a workspace having a space identifier, and
wherein the page is stored in the first database,
modifying a property of the page in the first database to indicate that the page is in the second logical location;
determining a deletion time, the deletion time indicating an amount of time for the page to remain in the second logical location;
determining, based on the deletion time and a current date, a deletion date for the page;
storing, in a second database, the deletion date and the space identifier,
wherein the second database is configured to store a mapping between a plurality of space identifiers and a plurality of deletion dates, each space identifier associated with a different workspace;
querying the second database to determine one or more space identifiers associated with a deletion date matching the current date;
determining one or more pages associated with each of the determined one or more space identifiers with a deletion date equal to the current date; and
updating a property of each of the one or more pages to indicate that the page is in a third logical location,
wherein the third logical location indicates a deleted state, and
wherein pages in the deleted state are not visible in the live location or the trash.

12. The system of claim 11, further comprising:
identifying, for each of the one or more pages in the third location, a purge date, wherein the purge date is determined based on the current date and a retention period;
determining, based on the current date and the purge dates for each of the one or more pages in the third logical location, one or more pages to be purged; and
purging the one or more pages to be purged,
wherein purging the one or more pages to be purged comprises deleting database records in the first database associated with the one or more pages to be purged.

13. The system of claim 11, wherein the second database is a key-value store.

14. The system of claim 11, wherein determining one or more pages associated with each of the determined one or more space identifiers with a deletion date equal to the current date comprises:
querying the first database to identify pages associated with the determined one or more space identifiers and having a deletion date equal to the current date.

15. The system of claim 14, wherein the deletion date is determined by adding the deletion time to a time when the page was moved to the second logical location.

16. The system of claim 11, wherein updating a property of each of the one or more pages to indicate that the page is in a third logical location is performed using a plurality of processes, wherein each process of the plurality of processes is configured to perform the updating on pages associated with a space identifier of the one or more space identifiers.

17. The system of claim 11, wherein the page comprises a parent block and a child block, and
wherein modifying a property of the page in the first database to indicate that the page is in the second logical location comprises modifying a property of the parent block.

18. The system of claim 12, further comprising:
providing, in response to a second user request from a user, a list of pages in the third logical location;
receiving a third user request from the user to restore a selected page from the third logical location to a fourth logical location; and
restoring the selected page to the fourth logical location.

19. The system of claim 18, wherein the fourth logical location is the first logical location, and wherein restoring the selected page to the fourth logical location comprises:
updating metadata of the selected page to indicate that the selected page is in first logical location; and
applying a set of permissions to the selected page, the set of permissions configured to at least partially match a previous set of permissions of the selected page before the page was moved from the first logical location to a second logical location.

20. The system of claim 18, further comprising:
determining a private space of the user;
identifying the fourth logical location as the private space of the user;
determining a set of permissions to apply to the selected page, wherein the set of permissions is at least one of: a set of permissions provided by the user or a set of default permissions for the private space of the user; and
updating metadata of the selected page to indicate that the page is in the private space of the user; and
applying the determined set of permissions to the selected page.
